(19) United States
(12) Patent Application Publication
(10) Pub. No.: US 2016/0053532 A1
(43) Pub. Date: Feb. 25, 2016

(54) WINDOW COVERING AND TIGHTENER OF THE SAME

(71) Applicant: NIEN MADE ENTERPRISE CO., LTD., Taichung City (TW)

(72) Inventor: DE-JUN ZHANG, Taichung (TW)

(21) Appl. No.: 14/677,506

(22) Filed: Apr. 2, 2015

(30) Foreign Application Priority Data
Aug. 19, 2014 (CN) 201420467625.4

(51) Int. Cl. E06B 9/26

(52) U.S. Cl. CPC E06B 9/26

(57) ABSTRACT

A window covering and tighteners of the window covering are provided, wherein each of the tighteners is a closed frame having an inner surface and an outer surface. The space surrounded by the inner surface forms a through hole and a gap which are communicated with each other, wherein the through hole allows a cord, which moves a bottom rail relative to a headrail of the window covering, to pass therethrough, and the width of the gap is less than the diameter of the cord. Whereby, if the cord is accidentally pulled away from the shades laterally or horizontally, the cord quickly and smoothly enters the gap to be tightly bitten therein. The cord is hence stopped from being further pulled outwardly to form a hazardous loop which may cause serious injuries to users.

The current application claims a foreign priority to application number 201420467625.4 filed in China on Aug. 19, 2014.

### BACKGROUND OF THE INVENTION

1. Technical Field

The present invention relates generally to a retaining ring for retaining cords, and more particularly to a window covering and a tightener for cords of the window covering.

2. Description of Related Art

Retaining rings are widely used for connecting objects or restricting an object from being moved. Take the retaining rings 1, which are circlips, shown in FIG. 1 for example, each retaining ring 1 is round in shape, and is respectively fixed on the window covering material 2 of a window covering, which is a Roman shade in FIG. 1. Each of cords 3 for expanding or collapsing the window covering material 2 passes through a plurality of the retaining rings 1 sequentially, which prevents the cords 3 from being easily pulled out laterally.

However, though the retaining rings 1 can restrict the cords 3 from being pulled out excessively, the section of each cord 3 between two neighboring retaining rings can be still pulled out for a certain length sufficient to form a loop, which can be hazardous, especially for children playing around.

### BRIEF SUMMARY OF THE INVENTION

In view of the above, the primary objective of the present invention is to provide a window covering and a tightener of the window covering, which better ensure safety.

The tightener provided in the present invention is a closed frame having an inner surface and an outer surface, wherein a space surrounded by the inner surface allows a cord to pass through. The shape of the inner surface forms a gap, of which a width is less than a diameter of the cord.

The present invention further provides a window covering, which includes a headrail, a bottom rail, a window covering material connecting the headrail and the bottom rail, a plurality of tighteners fixedly arranged on the window covering material in a vertical column, and a cord. Each of the tighteners has a through hole, and the cord passes through the through holes of the tighteners, wherein the cord moves the bottom rail relative to the headrail to expand or collapse the window covering material. Each of the tighteners is a closed frame having an inner surface and an outer surface, and the shape of the inner surface forms a gap, of which a width is less than a diameter of the cord.

In an embodiment, the gap has an open end and a closed end. The width of the gap is gradually narrower from the open end to the closed end.

In an embodiment, the gap has an open end and a closed end. The width of the gap is constant from the open end to the closed end.

In an embodiment, the gap is provided with a friction member on side walls thereof to create friction on the cord when the cord is in the gap.

In an embodiment, the friction member includes a plurality of teeth provided on the side walls of the gap.

Whereby, the gap tightly bites the cord to prevent it from being further pulled out.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a conventional Roman shade;

FIG. 2 is a perspective view of a first preferred embodiment of the present invention;

FIG. 3 is a top view of the first preferred embodiment of the present invention;

FIG. 4 is a perspective view of the window covering containing the first preferred embodiment of the present invention;

FIG. 5 is a partial enlarged view of FIG. 4, showing one of the cords passing through the through hole of the tightener;

FIG. 6 is a top view of the first preferred embodiment, showing the passing through cord enters the gap of the tightener;

FIG. 7 is a top view of a second preferred embodiment, showing the side walls of the gap are provided with teeth;

FIG. 8 is a partial enlarge view of the window covering containing a third preferred embodiment of the present invention, showing one of the cords passing through the through hole of the tightener; and

FIG. 9 is a top view of the third preferred embodiment, showing the passing through cord enters one of the gaps of the tightener.

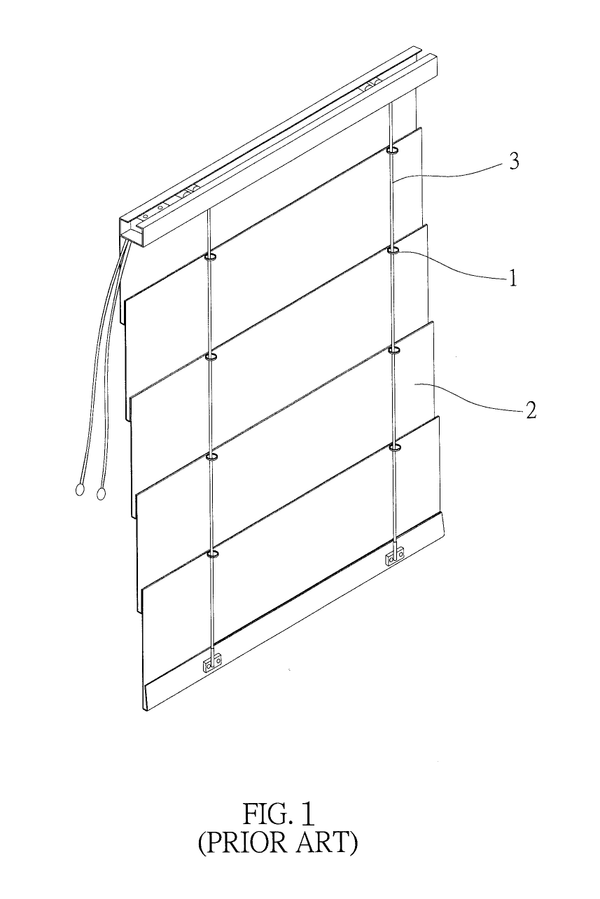

### DETAILED DESCRIPTION OF THE INVENTION

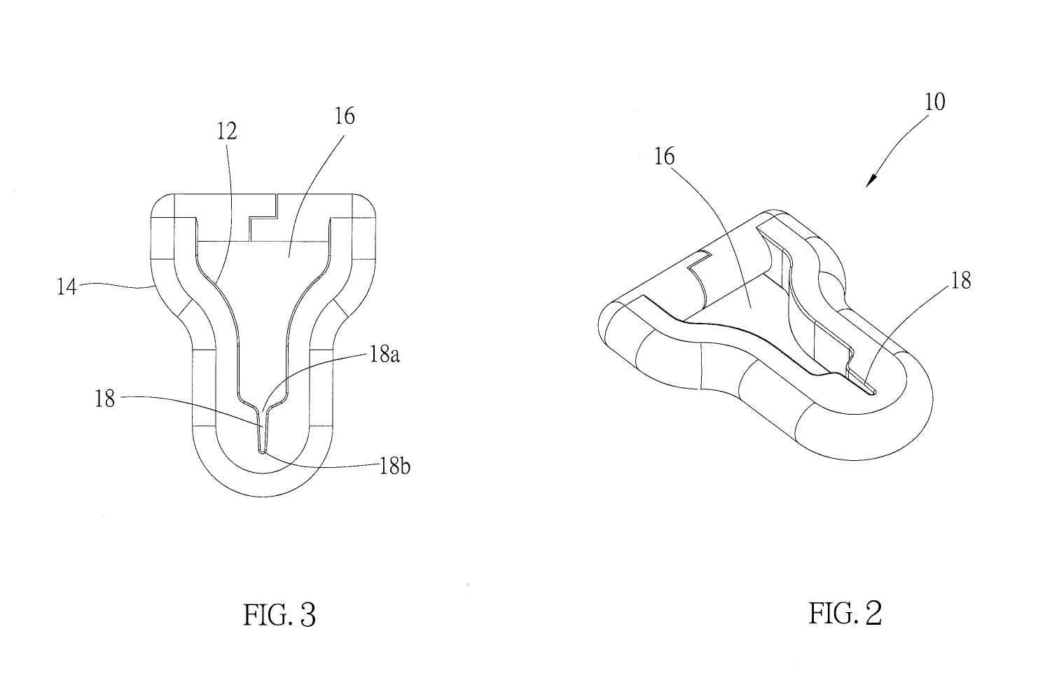

As shown in FIG. 2 and FIG. 3, a tightener 10 of the first preferred embodiment of the present invention is a closed frame, of which an end is wider than an opposite end, and the tightener 10 has an inner surface 12 and an outer surface 14, wherein the space surrounded by the inner surface 12 forms a through hole 16 and a gap 18. The gap 18 is formed near the narrower end of the tightener 10, and has an open end 18a and a closed end 18b in the first preferred embodiment, wherein the open end 18a communicates with the through hole 16. The gap 18 becomes gradually narrower from the open end 18a to the closed end 18b.

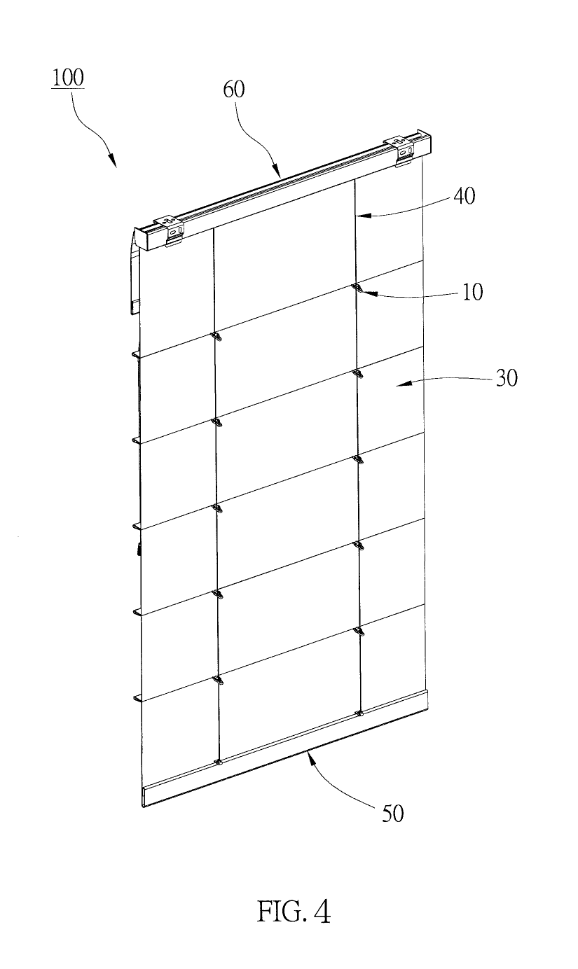

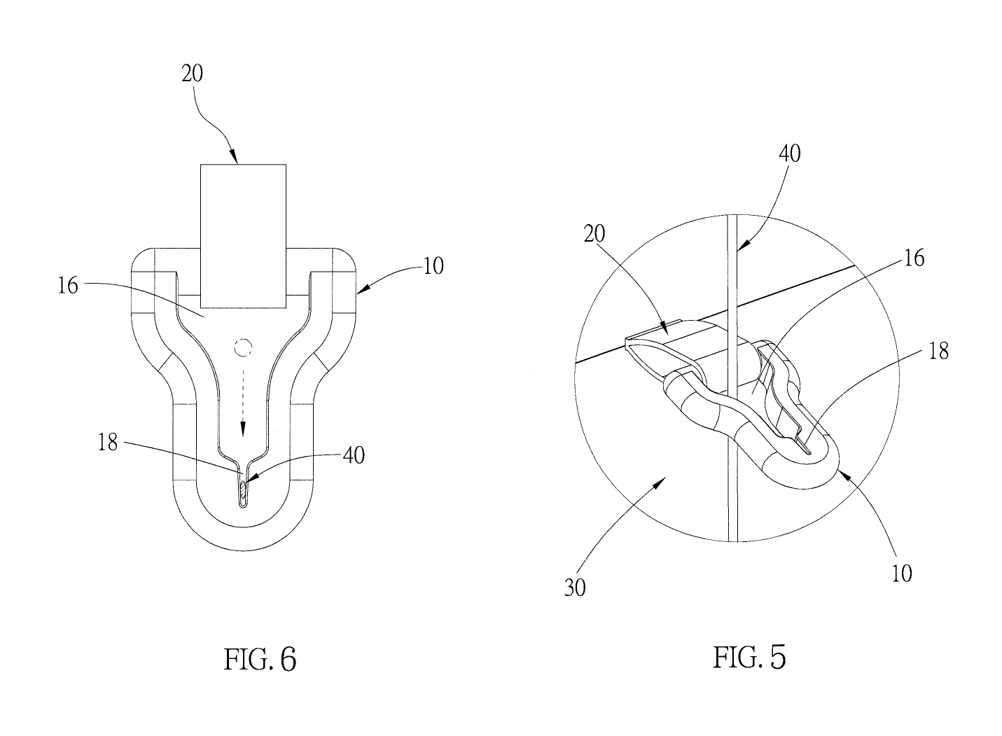

In an application shown in FIG. 4 and FIG. 5, a plurality of the tighteners 10 are fixed on a window covering material 30 of a window covering with bands 20, wherein the tighteners 10 are arranged vertically in two parallel columns, and the through holes 16 of the tighteners 10 in the same column respectively allow one cord 40 to pass through. The window covering is a Roman shade 100 in the current application. However, the type of the window covering should not be considered as a limitation of the present invention. The cords 40 are used to move a bottom rail 50 relative to a headrail 60 to expand or collapse the window covering material 30. In the first preferred embodiment, the through hole 16 of each of the tighteners 10 is wider than the cord 40 passes therethrough, while the width of the gap 18 of each of the tighteners 10 is less than the diameter of the cord 40. In this way, the cords 40 can be pulled in the through holes 16 in a vertical direction without being hindered, which ensures the bottom rail 50 can be steadily moved up and down.

If one of the cords 40 is pulled laterally or horizontally, a section of the pulled cord 40 between two neighboring tighteners 10 is moved toward the narrower ends of the relevant tighteners 10. As shown in FIG. 6, since the gap 18 of each of the tighteners 10 becomes gradually narrower from the open end 18a to the closed end 18b, the pulled cord 40 quickly and smoothly enters the gap 18 of each of the tighteners 10 to be tightly bitten therein. At this time, the pulled cord 40 is immediately stopped from being further pulled outwardly to form a hazardous loop, which might cause serious injuries by entangling around the neck of someone nearby. Therefore, the aforementioned design can effectively improve the safety of using the cords 40. In practice, the width of the gap 18 can be constant from the open end 18a to the closed end 18b, as long as the corresponding cord 40 can be tightly bitten in the gap 18.

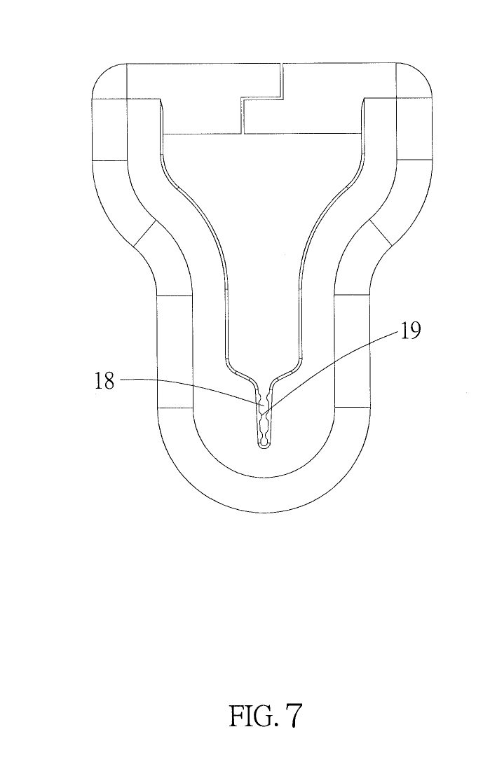

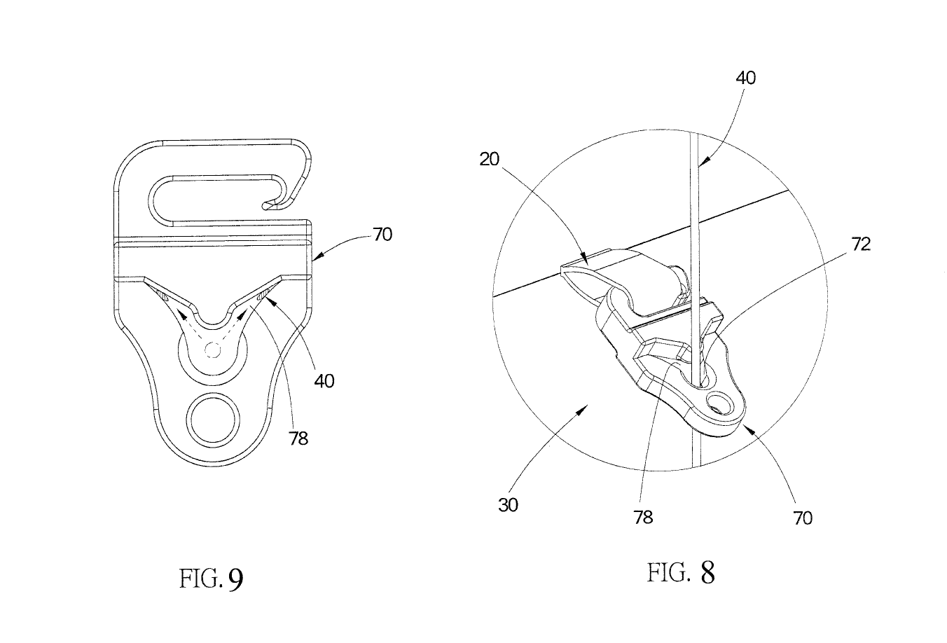

To further enhance the safety, the gap 18 can be provided with a friction member on both side walls thereof. After the corresponding cord 40 enters the gap 18, the friction member creates friction on the cord 40, which makes the cord 40 more difficult to be pulled outwardly. In the second preferred embodiment shown in FIG. 7, the friction member includes a plurality of teeth 19 provided on the side walls to bite the corresponding cord 40 more tightly. It is worth mentioning that, though the number of the gap 18 is only one in the aforementioned embodiments, the inner surface 12 can have different shapes to form more than one gap in practice. As shown in FIG. 8 and FIG. 9, a tightener 70 of the third preferred embodiment of the present invention has similar structure with the aforementioned embodiments, except that an inner surface 72 of the tightener 70 forms two gaps 78 extending toward two opposite lateral sides, wherein each of the gaps 78 provides the same function as the gap 18 of the first preferred embodiment, and therefore the gaps 78 are not described in detail herein. With such design, no matter which lateral direction the passing through cord 40 is pulled in, the cord 40 would easily enter the closest gap 78 to be tightly bitten therein, which further ensures safety.

It must be pointed out that the embodiments described above are only some preferred embodiments of the present invention. All equivalent structures which employ the concepts disclosed in this specification and the appended claims should fall within the scope of the present invention.

What is claimed is:

1. A tightener, which is a closed frame having an inner surface and an outer surface, wherein a space surrounded by the inner surface allows a cord to pass through, is characterized in that:
the shape of the inner surface forms a gap, of which a width is less than a diameter of the cord.

2. The tightener of claim 1, wherein the gap has an open end and a closed end; the width of the gap becomes gradually narrower from the open end to the closed end.

3. The tightener of claim 1, wherein the gap has an open end and a closed end; the width of the gap is constant from the open end to the closed end.

4. The tightener of claim 1, wherein the gap is provided with a friction member on side walls thereof; the friction member creates friction on the cord when the cord is in the gap.

5. The tightener of claim 4, wherein the friction member includes a plurality of teeth provided on the side walls of the gap.

6. A window covering, comprising:
a headrail;
a bottom rail;
a window covering material arranged between the headrail and the bottom rail;
a plurality of tighteners fixedly arranged on the window covering material in a vertical column, wherein each of the tighteners has a through hole; and
a cord passing through the through holes of the tighteners, wherein the cord moves the bottom rail relative to the headrail to expand or collapse the window covering material;
is characterized in that:
each of the tighteners is a closed frame having an inner surface and an outer surface, and the shape of the inner surface forms a gap, of which a width is less than a diameter of the cord.

7. The window covering of claim 6, wherein the gap of each of the tighteners has an open end and a closed end; the width of the gap becomes gradually narrower from the open end to the closed end.

8. The window covering of claim 6, wherein the gap of each of the tighteners has an open end and a closed end; the width of the gap is constant from the open end to the closed end.

9. The window covering of claim 6, wherein the gap of each of the tighteners is provided with a friction member on side walls thereof; the friction member creates friction on the cord when the cord is in the gap.

10. The window covering of claim 9, wherein the friction member includes a plurality of teeth provided on the side walls of the gap of each of the tighteners.
